(19) United States
(12) Patent Application Publication
(10) Pub. No.: US 2005/0039802 A1
(43) Pub. Date: Feb. 24, 2005

(54) Fluid transfer interface

(75) Inventor: Jacob De Baan, Maassluis (NL)

Correspondence Address: FULWIDER PATTON LEE & UTECHT, LLP, 200 OCEANGATE, SUITE 1550, LONG BEACH, CA, 90802, US

(73) Assignee: BLUEWATER ENERGY SERVICES BV

(21) Appl. No.: 10/644,407

(22) Filed: Aug. 19, 2003

(51) Int. Cl. F16L 37/28

(52) U.S. Cl. 137/615

(57) ABSTRACT

An apparatus for connecting fluid flowlines to a (5) floating vessel. The apparatus comprises a floating transfer structure supporting a plurality of fluid pipelines. A plurality of flexible fluid conduits (2) each have a proximal end attached to the transfer structure in fluid communication with the pipelines 10 and a distal end attached to a common connector (4) for releasably engaging with the floating vessel. The connector has a longitudinal axis which is substantially vertical in use, and is secured to a manipulator means (7) mounted on the transfer (15) structure. The manipulator means is configured to allow the connector to rotate and to translate in two mutually perpendicular planes.

The present invention relates to apparatus for transferring fluid between two structures, for example two floating vessels, or a fixed offshore structure and a vessel, in open sea.

Transferring fluids, particularly of a cryogenic product, between two floating vessels, or a fixed offshore structure and a vessel, is a difficult and hazardous operation when performed in open sea. Various rigid loading systems have been proposed for transferring fluid using fixed arms through which rigid articulated pipes are routed. However, these systems are generally intended for the transfer of fluid between vessels at sheltered inshore moorings. When operating offshore, the relative motions and displacements between two floating vessels, typically a production or storage vessel and a receiving vessel, are much greater. Subjecting known rigid loading systems to the loads imposed under such open sea conditions significantly reduces their working life.

An alternative to a rigid loading system may be achieved by using flexible lines. Flexible lines afford much better manoeuvrability than rigid articulated pipes, but they are inherently more difficult to handle. The use of flexible lines for connections between vessels is known in the art, but invariably the connections between a production or storage vessel and the manifold of a receiving vessel (typically a tanker) must be made with the use of external wires and winches. Carrying out connections in this way under open sea conditions poses significant difficulties. Furthermore, it is generally the case that connection of each flexible line must be made individually. Control over the flexible lines, of which there are usually a minimum of three, in an emergency disconnection situation is therefore severely hindered.

Accordingly, the present invention provides apparatus for connecting fluid flowlines to a floating vessel, comprising a floating transfer structure supporting a plurality of fluid pipelines, a plurality of flexible fluid conduits, each with a proximal end attached to the transfer structure in fluid communication with the pipelines and a distal end attached to a common connector for releasably engaging with the floating vessel, the connector having a longitudinal axis which is substantially vertical in use, and wherein the connector is secured to a manipulator means mounted on the transfer structure, the manipulator means configured to allow the connector to rotate and to translate in two mutually perpendicular planes.

In a preferred embodiment, the manipulator means comprises a support tower extending upwardly from floating transfer structure, an arm projecting laterally from the tower, and a suspension member attached to the distal end of the arm and to which the connector is mounted.

Preferably, in use, the arm is rotatable relative to the tower about a substantially vertical axis and is extendable and retractable in a substantially horizontal plane.

Additionally, the suspension member, or part thereof, is preferably extendible and retractable and rotatable about its longitudinal axis.

Conveniently, the suspension member is joined to the arm by a joint allowing rotation about two mutually perpendicular axes.

In addition, the connector may be joined to the suspension member by a joint allowing rotation about two mutually perpendicular axes.

Furthermore, the connector is rotatable about its longitudinal axis relative to the suspension member by means incorporated in the connector.

Advantageously, the connector comprises a coupling device suspended therefrom by a winch mechanism operable to lower to the coupling device into engagement with the vessel and subsequently to pull the connector into engagement with the vessel.

Preferably, the connector also comprises an aperture extending transversely therethrough and slideably receiving rigid end pieces attached to the distal ends of the flexible fluid conduits, wherein the end pieces are releasably connectable to the vessel to allow fluid flow from the flexible conduits to the vessel.

The rigid end pieces may include valve means to shut off fluid flow.

The invention will now be described in detail, by way of example only, with reference to the accompanying drawings in which:

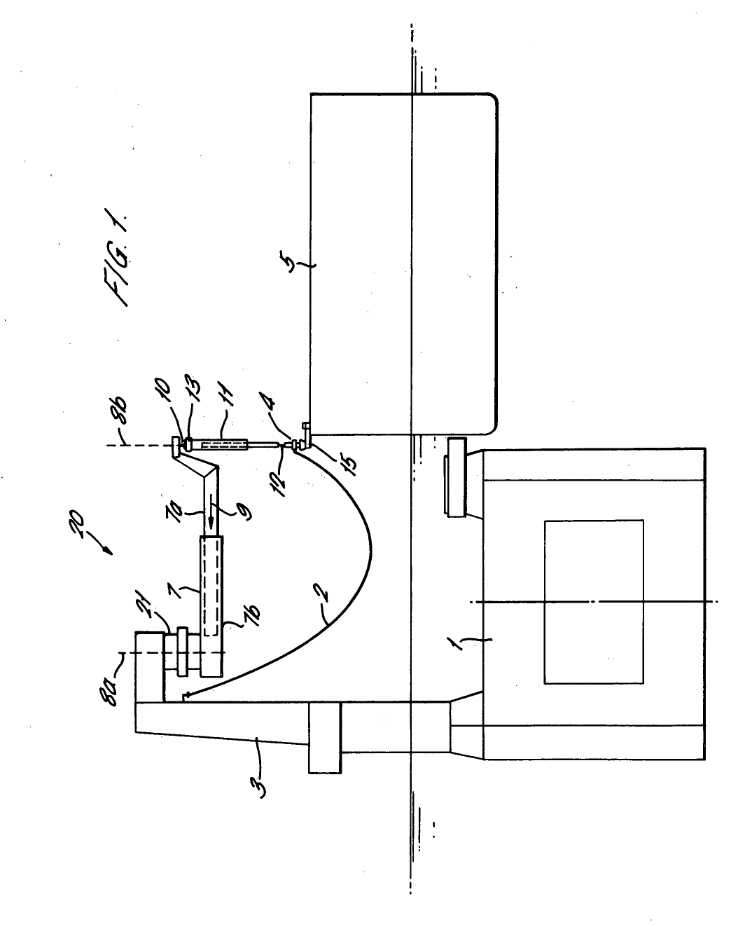

FIG. 1 is a schematic diagram of a system for transferring fluid from a production or storage vessel via a rigid transfer arm to a receiving vessel in accordance with a first embodiment of the invention; and

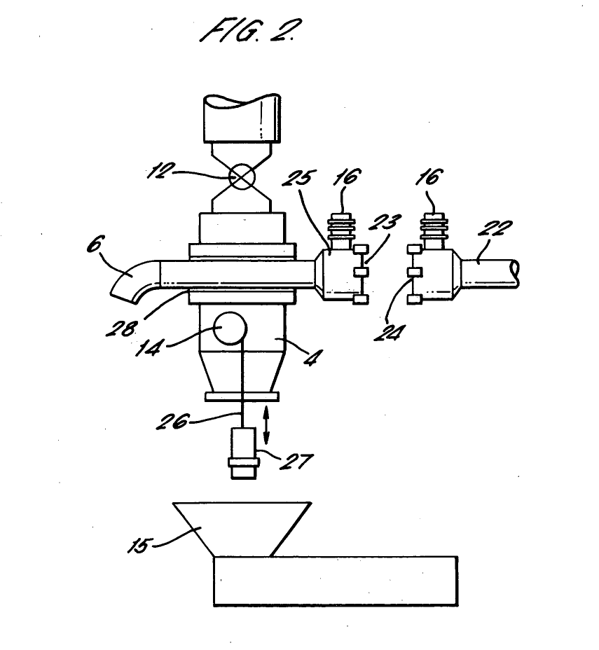

FIG. 2 is an enlarged schematic view of the connection point between the apparatus of FIG. 1 and the receiving vessel.

FIG. 1 shows the loading system 20 of the present invention, supported by a rigid transfer arm 1, and docked with a receiving vessel 5.

The rigid transfer arm 1, the end elevation of which is shown in FIG. 1, enables fluid transfer to take place between the two vessels moored at a safe distance from each other. The rigid transfer arm 1 is a submerged structure, for example of the type described in GB 2328196. It is typically of space frame construction, made up of hollow elements through which fluid flow lines, usually rigid articulated steel pipes, are routed. At its first end (not shown), there are means for attaching the rigid arm 1 to a structure such as a production or storage vessel. At its second end, floatation means are provided to support the rigid transfer arm 1 underwater and in a substantially horizontal orientation, supporting the weight of the arm 1 and the flexible loading system 20.

The rigid transfer arm 1 may be attached to the stem of the production/storage vessel. It is of sufficient length such that when the receiving vessel 5 is moored at the desired safe distance from, and aligned with, the production/storage vessel, the rigid transfer arm 1 is oriented in a substantially parallel direction to both vessels, and the loading system 20 is located generally adjacent to the midship region of the receiving vessel 5. To retain the correct orientation of the rigid transfer arm 1, to prevent collision or separation between the rigid transfer arm 1 and the vessel 5, the rigid transfer arm 1 may be equipped with one or more thrusters remotely controlled via a position monitoring system.

Before commencement of fluid transfer the rigid transfer arm 1 must be docked with the receiving vessel 5. In the present invention the connection is two fold. A first structural connection is made using a structural connector 4 supported from the flexible loading system 20. A second fluid connection is made between flexible hoses described below and rigid connection points 22 disposed on the receiving vessel 5.

The flexible loading system 20 consists of a generally vertical support tower 3 and a manipulator arm 7. The tower 3 is mounted on the rigid arm 1 and extends up above the water line to a height which will be well above the deck of the receiving vessel 5. The manipulator arm 7 extends generally horizontally from the upper region of the tower 3.

The proximal end of the arm 7 is attached via shoulder 21 to the tower 3, allowing rotation of the arm 7 about a first substantially vertical axis 8a. The manipulator arm 7 is extendable and retractable in a generally horizontal direction shown by arrows 9, by means of two telescopic sections 7a, 7b.

A joint 10 allowing rotation about two generally horizontal axes is provided at the distal end of the arm 7 for connecting the arm 7 to a suspension member 11 which extends downwardly. The suspension member 11 is preferably a hydraulic or pneumatic cylinder, allowing it to extend and contract in a generally vertical direction.

A structural connector 4, for connection to the receiving vessel 5 at a coupler 15 (described further below), is attached to the lower end of the suspension member 11, preferably by another joint 12 which allows rotation about two generally horizontal axes. In addition the connector 4 is able to rotate to some extent, typically through a total range of about 60 degrees, about a second generally vertical axis 8b. This rotation may be implemented by means incorporated within the body of the connector.

A plurality of generally parallel flexible hoses 2 are suspended between the tower 3 and the structural connector 4 such that they assume a catenary form. These hoses 2 are in fluid communication with the rigid flow lines running through the submerged transfer arm 1.

The purpose of the manipulator arm 7 is to maneuver the structural connector 4 and hence the flexible hoses 2 into a suitable position for connection with the receiving vessel 5.

Due to the structure of the manipulator arm 7 described above, the connector 4 is able to rotate in a horizontal plane about the first vertical axis 8a, and translate in a horizontal plane in the direction of arrow 9, relative to the tower 3.

Due to the suspension member 11 and joints 10,12, the connector 4 is able to rotate in a horizontal plane about the second vertical axis 8b and translate in a vertical plane along the axis 8b. In addition, the joint 10 allows the suspension member 11 to rotate about two horizontal axes relative to the arm 7. Similarly, the joint 12 allows the connector 4 to rotate about two horizontal axes relative to the suspension member 11.

This provides significant freedom of movement to the connector 4 relative to the tower 3, to facilitate connection to the receiving vessel 5.

FIG. 2 shows the structural connector 4, the flexible hoses 2 and a corresponding fixed coupler 15 mounted on the receiving vessel 5, in greater detail. The fixed coupler 15 is preferably generally frusto conical in shape, the wide end of the cone positioned uppermost in order to guide the connector 4 into place. The connector 4 is tapered towards its lower end to locate within the fixed coupler 15.

To facilitate connection of the connector 4 to the fixed coupler 15, the connector 4 preferably utilizes a remote connection device. The device comprises a winch 14, a wire 26 and a deployable coupler 27 attached to the end of the wire 26. Connection between the deployable coupler 27 and the fixed coupler 15 and subsequent retraction of the wire 26 by the winch 14 enables the structural connector 4 to be pulled in to the fixed coupler 15. The actual connection between the connector 4 and the fixed coupler 15 may be made by any suitable means.

The connector 4 includes one or more generally transverse openings 28 to receive and support the ends of the flexible hoses 2. Each flexible hose 2 has at its distal end a spool piece 6, which passes through the opening 28.

Once a structural connection has been made between the flexible loading system 20 and the receiving vessel 5, by means of the connector 4 and fixed coupler 15, a fluid connection can be made between the flexible hoses 2 and the receiving vessel 5. In particular, each of the spool pieces 6 attached to the flexible hoses 2 can be slid axially through the opening 28 in the structural connector 4 and this allows the flexible hoses 2 to be brought into contact with corresponding rigid connection points 22 disposed on the receiving vessel 5.

In this example, each spool piece 6 can be slid through opening 28 for about 300-500 mm in a direction along its axis towards the rigid connection points 22 on the receiving vessel 5. When the spool pieces 6 and the connection points 22 are aligned, the end faces 23 of the spool pieces 6 are mated with the corresponding faces 24 of the connection points 22 on the receiving vessel 5. However, should the spool pieces 6 be out of line with the rigid connection points 22 the connector 4 can rotate as described above to align the end faces 23 and the connector faces 24 of the receiving vessel 5.

Dual shut-off valves 16 may be provided on both connection points 22,25 to reduce the risk of leakage of fluid from at the end faces 23,24. The procedure for disconnecting the flexible hoses 2 from the vessel 5 and for disconnecting the structural connector 4 from the fixed coupler 15 takes place in the reverse order to the connection procedure.

Preferably the loading system 20 incorporates rotational and translational position sensors in order to determine the position of the various parts of the system relative to the receiving vessel 5 at all times to ensure that the system 20 is operating within allowable parameters.

It will be appreciated from the foregoing description that the invention provides an improved fluid transfer interface. In particular, the connection operation is simplified by combining all the flexible hoses into a single structural connector, 5 yet maintaining the individual flow paths. The manipulator arm 7 controls the most critical axes of freedom of the connector 4 and the manipulator 7 and the hoses 2 absorb the differential movements of the receiving vessel 5 and the arm 1/tower 3 structure, 10 caused by motion of the receiving vessel 5 with the waves. The reader will realize that various modifications and variations to the specific embodiments described are also possible without departing from the scope of the claims.

1. Apparatus for connecting fluid flowlines to a floating vessel, comprising a floating transfer structure supporting a plurality of fluid pipelines, a plurality of flexible fluid conduits, each with a proximal end attached to the transfer structure in fluid communication with the pipelines and a distal end attached to a common connector for releasably engaging with the floating vessel, the connector having a longitudinal axis which is substantially vertical in use, and wherein the connector is secured to a manipulator means mounted on the transfer structure, the manipulator means configured to allow the connector to rotate and to translate in two mutually perpendicular planes.

2. Apparatus as claimed in claim 1, wherein the manipulator means comprises a support tower extending upwardly from floating transfer structure, an arm projecting laterally from the tower, and a suspension member attached to the distal end of the arm and to which the connector is mounted.

3. Apparatus as claimed in claim 1, wherein the connector comprises a coupling device suspended therefrom by a winch mechanism operable to lower to the coupling device into engagement with the vessel and subsequently to pull the connector into engagement with the vessel.

4. Apparatus as claimed in claim 1, wherein the connector comprises an aperture extending transversely therethrough and slideably receiving rigid end pieces attached to the distal ends of the flexible fluid conduits, wherein the end pieces are releasably connectable to the vessel to allow fluid flow from the flexible conduits to the vessel.

5. Apparatus as claimed in claim 2, wherein in use the arm is rotatable relative to the tower about a substantially vertical axis and is extendable and retractable in a substantially horizontal plane.

6. Apparatus as claimed in claim 2, wherein the suspension member, or part thereof, is extendible and retractable and rotatable about its longitudinal axis.

7. Apparatus as claimed in claim 2, wherein the suspension member is joined to the arm by a joint allowing rotation about two mutually perpendicular axes.

8. Apparatus as claimed in claim 2, wherein the suspension member, or part thereof, is extendible and retractable and rotatable about its longitudinal axis and the connector is joined to the suspension member by a joint allowing rotation about two mutually perpendicular axes.

9. Apparatus as claimed in claim 2, wherein the connector is joined to the suspension member by a joint allowing rotation about two mutually perpendicular axes and wherein the use arm is rotatable relative to the tower about a substantially vertical axis and is extendable and retractable in a substantially horizontal plane.

10. Apparatus as claimed in claim 3, wherein the suspension member, or part thereof, is extendible and retractable and rotatable about its longitudinal axis.

11. Apparatus as claimed in claim 3, wherein the connector is joined to the suspension member by a joint allowing rotation about two mutually perpendicular axes.

12. Apparatus as claimed in claim 3, wherein the connector is rotatable about its longitudinal axis relative to the suspension member by means incorporated in the connector.

13. Apparatus as claimed in claim 4, wherein the connector is joined to the suspension member by a joint allowing rotation about two mutually perpendicular axes.

14. Apparatus as claimed in claim 4, wherein the connector is rotatable about its longitudinal axis relative to the suspension member by means incorporated in the connector.

15. Apparatus as claimed in claim 5, wherein the connector is joined to the suspension member by a joint allowing rotation about two mutually perpendicular axes.

16. Apparatus as claimed in claim 5, wherein the connector is rotatable about its longitudinal axis relative to the suspension member by means incorporated in the connector.

17. Apparatus as claimed in claim 5, wherein the connector comprises an aperture extending transversely therethrough and slideably receiving rigid end pieces attached to the distal ends of the flexible fluid conduits, wherein the end pieces are releasably connectable to the vessel to allow fluid flow from the flexible conduits to the vessel.

18. Apparatus as claimed in claim 17, wherein the rigid end pieces include valve means to shut off fluid flow.

19. Apparatus as claimed in claim 18, wherein the connector comprises an aperture extending transversely therethrough and slideably receiving rigid end pieces attached to the distal ends of the flexible fluid conduits, wherein the end pieces are releasably connectable to the vessel to allow fluid flow from the flexible conduits to the vessel.

20. Apparatus as claimed in claim 19, wherein the rigid end pieces include valve means to shut off fluid flow and the connector is rotatable about its longitudinal axis relative to the suspension member by means incorporated in the connector.
